(19) United States
(12) Patent Application Publication
(10) Pub. No.: US 2009/0072614 A1
(43) Pub. Date: Mar. 19, 2009

(54) Connection Element and Brake Pliers

(76) Inventors: Stefan Ruckh, Romerstein (DE); Jurgen Beier, Ulm (DE)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/158,805

(22) PCT Filed: Dec. 18, 2006
(86) PCT No.: PCT/EP2006/012200

§ 371 Date: Jun. 23, 2008

(30) Foreign Application Priority Data
Dec. 23, 2005 (DE) 102005061903.7

(51) Int. Cl. F16L 27/087; F16D 65/14; B62L 1/00

(52) U.S. Cl. 303/49; 188/264 F; 188/75

(57) ABSTRACT

A connection element (20) is disclosed for connecting a hydraulic pipe to brake pliers, a brake cylinder, a slave cylinder and/or a master cylinder for a hydraulic brake and/or hydraulic clutch, in particular for motorcycles and/or bicycles. The connection element (20) has a fastening section (20A) for fastening the hydraulic pipe to the connection element (20), and a connection section (20B) for connecting the connection element (20) to the element of the hydraulic system. The connection section (20) has a ring-shaped zone (24) and at least one extension that extends away from the ring-shaped zone (24), substantially to the side of the ring plane. Also disclosed are brake pliers (30) for a hydraulic brake, in particular for motorcycles and/or bicycles, having a housing (31) in which a disk chamber for receiving a disk brake and at least one brake cylinder for receiving a brake piston (43) are formed. A connection aperture (33) is provided in the housing for receiving a connection element (20) for connecting a hydraulic pipe to the brake pliers (30), the connection aperture (33) being designed in such a way that the connection element (20) can be plugged into the connection aperture (33) and the brake pliers comprise securing means for securing the connection element (20) in the connection aperture (33) in a form-fitting manner.

The present invention relates to connection pieces for a hydraulic pipe to a brake calliper according to the precharacterizing clause of one of the corresponding independent claims relating thereto and a brake calliper according to the precharacterizing clauses of one of the corresponding independent claims relating thereto.

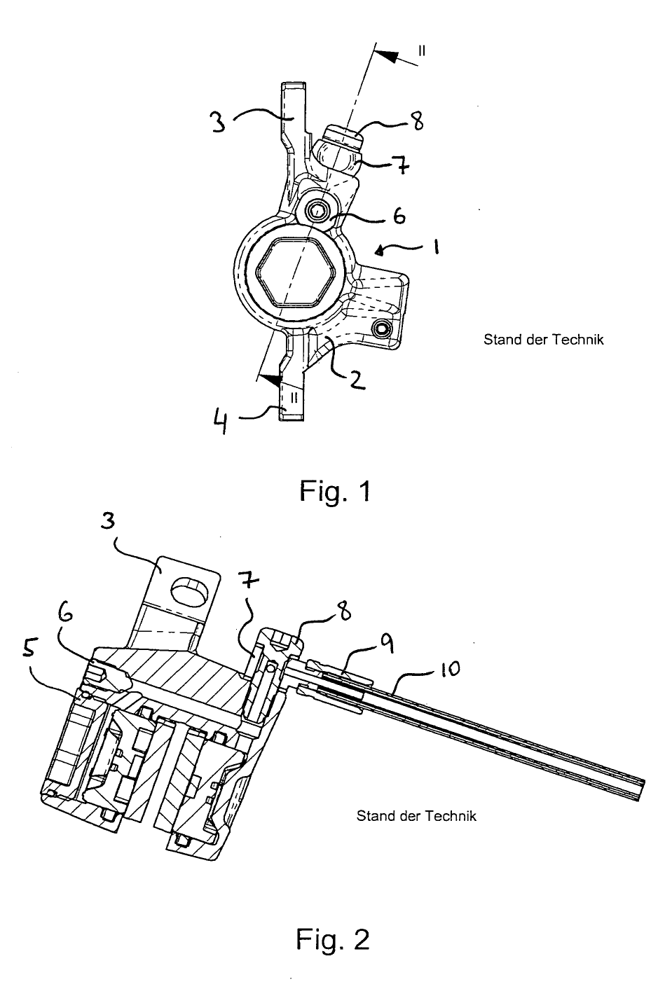

FIGS. 1 and 2 show, by way of example, a known connection piece for a previously known brake calliper sold by the present applicant.

FIG. 1 shows a side view of a known brake calliper 1 on which a known connection piece 7 is mounted. FIG. 2 shows a sectional view of the brake calliper 1 and of the connection piece 7 along the line II-II of FIG. 1.

The brake calliper has a housing 2 which can be fastened by means of fastening attachments 3, 4 to a frame part of a bicycle, which frame part is not shown. A brake cylinder is provided in the housing 2. A mounting opening through which a brake piston can be inserted into the brake cylinder is provided in the housing. The mounting opening is closed by a closure element 5 screwed into the mounting opening. A screw 6 serves for closing a vent bore after filling of the brake system with hydraulic fluid.

The connection piece 7 has a connection section having an annular region and a connection section for fastening the hydraulic pipe 10 to the connection piece 7. The hydraulic pipe has a clamping part 9 which is screwed for fastening onto the fastening section of the connection piece 7.

For fastening the connection piece 7 to the brake calliper 1, a hollow screw 8 is inserted through the annular region of the connection piece and screwed into a connection opening provided in the housing 2 and having an internal thread. This fastening has the advantage that the angle of the hydraulic pipe 10 relative to the housing 2 can be adapted to the conditions of the frame part of the bicycle.

Furthermore, a brake calliper from AVID is disclosed, which was presented at the EUROBIKE 2005 in Friedrichshafen. This brake calliper has a two-part housing. A connection piece similar to the connection piece described above and having a connection section with an annular region and a fastening section for fastening a hydraulic pipe to the connection piece is present between two attachments. A screw which extends through a hole in the attachment of one housing part, through the annular region of the connection section and through a hole in the attachment of the other housing part is provided for fastening the connection piece.

The known connection pieces and brake callipers have the disadvantage that the production of the parts required for the connection of the connection piece to the brake calliper and the corresponding formation of the housing of the brake calliper are complicated and expensive.

It is therefore the object of the invention to provide a connection piece or a brake calliper which are of simple design and are cheap to produce.

The subject of the invention is achieved by the features of claim 1 and claim 25, respectively. Advantageous developments of the invention are stated in the dependent claims.

According to this point of view, for example, a connection piece for connecting a hydraulic pipe to a brake calliper, a brake cylinder, a slave cylinder and/or a master cylinder for a hydraulic brake and/or hydraulic clutch, in particular for motorcycles and/or bicycles, having a fastening section for fastening the hydraulic pipe to the connection piece and a connection section for connecting the connection piece to the element of the hydraulic system is provided, the connection section having an annular region, the connection section having at least one extension which extends from the annular region substantially laterally to the plane of the ring.

This embodiment has the advantage that fewer parts are required for the connection, which parts in particular can be produced more easily and more economically. In particular, a hollow screw can be dispensed with. However, a screw or hollow screw can of course be additionally provided.

According to this point of view, for example, a brake calliper for a hydraulic brake is also provided, in particular for motorcycles and/or bicycles, comprising a housing in which a disc space for receiving a brake disc and at least one brake cylinder for receiving a brake piston are formed, a connection opening for receiving a connection piece for connecting a hydraulic pipe to the brake calliper being provided in the housing, the connection opening being formed in such a way that the connection piece can be inserted into the connection opening and that the brake calliper has securing means for securing the connection piece in the connection opening in an interlocking manner.

These features result in the above mentioned advantages. The combination of the connection piece according to the invention with the brake calliper according to the invention is particularly advantageous.

According to a preferred embodiment of the invention, the extension may be a lateral extension of the annular region. Alternatively or additionally, the extension may have an annular, preferably circular, surface. This has the advantage that the angle between the connection piece (and hence the hydraulic pipe) and the hydraulic component is adjustable.

Alternatively or additionally, the annular region and/or the extension and/or a transition region between annular region and extension may have a preferably segment-like recess. This has the advantage that the range of angle adjustability can be limited in a simple manner.

Alternatively or additionally, the extension may have a section, the cross-section of which is greater than the cross-section of the annular region. This has the advantage that the connection piece can be simply secured or clamped in an interlocking manner at the resulting transition or step. In this embodiment, the section of greater cross-section of the extension can form a flange for fastening the connection piece to the brake calliper. In addition or alternatively, in these embodiments the extension may have, between the annular region and the section of greater cross-section, an intermediate section, the cross-section of which preferably substantially corresponds to the cross-section of the annular region.

According to one embodiment of the invention, the cross-section of the extension can correspond to the cross-section of the annular region.

According to one embodiment of the invention, the extension may have an all-round groove for receiving a gasket.

Alternatively or additionally, the extension may have an all-round step for receiving a gasket.

Alternatively or additionally, the extension may have an all-round sealing surface which is preferably arranged at that end of the extension which is remote from the annular region.

According to the invention, a pipe can be formed in the extension.

According to some embodiments of the invention, the connection piece can be substantially L-shaped, the fastening section substantially forming a leg of the L of the substantially L-shaped connection piece, the annular region forming the connection region of the two legs of the L of the substantially L-shaped connection piece, and the extension forming the other leg of the L of the substantially L-shaped connection piece.

According to some embodiments of the invention, the extension can be formed on one side of the annular region.

According to some embodiments of the invention, the annular region may have, on the side opposite the extension, a wall which laterally seals the annular region.

According to some embodiments of the invention, the connection piece may have an extension on each of the two sides of the annular region. In other words the connection piece may also be substantially T-shaped or have the shape of a hammer head. The two extensions can preferably be formed symmetrically or identically. Alternatively, the two extensions may be of different lengths.

According to some embodiments of the invention, the connection piece may be formed at least partly and in particular in the region of the fastening section and preferably completely from a poorly heat-conducting material, for example from stainless steel. This has the advantage that the heat input of, for example, the brake calliper into the connected hydraulic pipe can be reduced.

According to some embodiments of the invention of a brake calliper according to the invention, the at least one brake cylinder can be connected to the disc space and can have, on its side opposite the disc space, a mounting opening through which the brake piston can be inserted into the brake cylinder. Advantageously, the brake calliper can have a closure element for closing the mounting opening, and the securing means can comprise the closure element.

According to some embodiments of the invention of a brake calliper according to the invention, the closure element can be screwed into the mounting opening and can have a flange for securing a connection piece arranged in the connection opening.

According to some embodiments of the invention of a brake calliper according to the invention, the connection opening may have a groove for receiving a sealing element for sealing a connection piece arranged in the connection opening. Advantageously, a radial seal having the advantages known to the person skilled in the art is formed. The same does of course apply if the sealing element is provided in a step or a groove of the extension on the connection piece.

According to some embodiments of the invention of a brake calliper according to the invention, the brake calliper may have a one-part housing and the connection opening can be arranged next to a mounting opening for a brake piston. Alternatively, the brake calliper may have a two-part housing, the connection opening preferably being arranged in at least one of the housing parts of the brake calliper, on its side opposite the other housing part. The securing means may comprise that housing part of the brake calliper which is opposite the connection opening. Furthermore, a connection opening can preferably be provided in each of the two housing parts. The two connection openings can preferably be opposite one another and preferably be symmetrical with respect to one another.

According to the invention, a brake calliper for a hydraulic brake is also provided, in particular according to one or any of the ten preceding claims and in particular for motorcycles and/or bicycles, comprising a housing in which are provided a disc space for receiving a brake disc and at least one brake cylinder for receiving a brake piston which is connected to the disc space and has, on its side opposite the disc space, a mounting opening through which the brake piston can be inserted into the brake cylinder, a closure element for closing the mounting opening and a connection piece for connecting a hydraulic pipe to the brake calliper, the closure element, in its position when it closes the mounting opening, securing the connection piece on the housing.

In the case of known hydraulic brake systems, there is the problem of the removal of the heat generated in the braking process. This is the case in particular with bicycles having a glass fibre-reinforced plastic frame because the glass-reinforced plastic material of the frame may be damaged in the event of the high heat input from the brake's calliper into the frame. A known solution to this problem is to provide cooling elements on the brake calliper in order to remove the resulting heat to the environment. In the case of bicycles having a metal frame, this problem does not arise because as a rule no cooling elements are provided on the brake calliper.

If a rider brakes for a protracted period at low speed, a possible problem is that the resulting heat cannot be removed rapidly enough and enters the hydraulic pipe via the connection piece. The hydraulic pipe consists as a rule of a plastic material which has a softening temperature of about 120 to 130° C.

According to one point of view, it is therefore the object of the invention to provide a connection piece which takes into account the above mentioned problems and reduces the risk of damage to the hydraulic pipe.

This object of the invention is achieved by the features of claim 20, and advantageous developments of the invention are stated in the dependent claims.

According to this point of view, for example, a connection piece for connecting a hydraulic pipe to a brake calliper for a hydraulic brake, in particular for motorcycles and/or bicycles, is provided, the connection piece having a cooling element for removing heat taken up from the brake calliper during the braking process and transmitted to the connection piece.

This embodiment has the advantage that the load on the hydraulic pipe is reduced.

According to one embodiment of the invention, the connection piece may have a fastening section for fastening the hydraulic pipe to the connection piece and a connection section for connecting the connection piece to the brake calliper of the hydraulic system, the cooling element being arranged on the fastening section.

Alternatively or additionally, the cooling element may have cooling ribs which are arranged in a substantially cuboid manner, it preferably being possible for the cooling element to be formed from a material having good thermal conductivity.

Alternatively or in addition, the or a further cooling element can be arranged on a fastening section of the hydraulic pipe or on the clamping piece for fastening the hydraulic pipe.

Preferred embodiments of the invention relate to the combination of the features of the above mentioned embodiments of the connection pieces according to the invention. Thus, connection pieces according to the invention may have, for example, at least one extension and at least one cooling element.

Preferred embodiments of the inventions also relate to the combination of a brake calliper according to the invention with a connection piece according to the invention, in particular to a hydraulic disc brake having a brake calliper according to the invention and/or a connection piece according to the invention.

Below, the invention is described more exactly with reference to the working examples of the invention which are shown in the figures.

FIG. 1 shows a side view of a known brake calliper having a connection piece according to the prior art.

FIG. 2 shows a side view of the brake calliper and of the connection piece of FIG. 1 along the line II-II of FIG. 1.

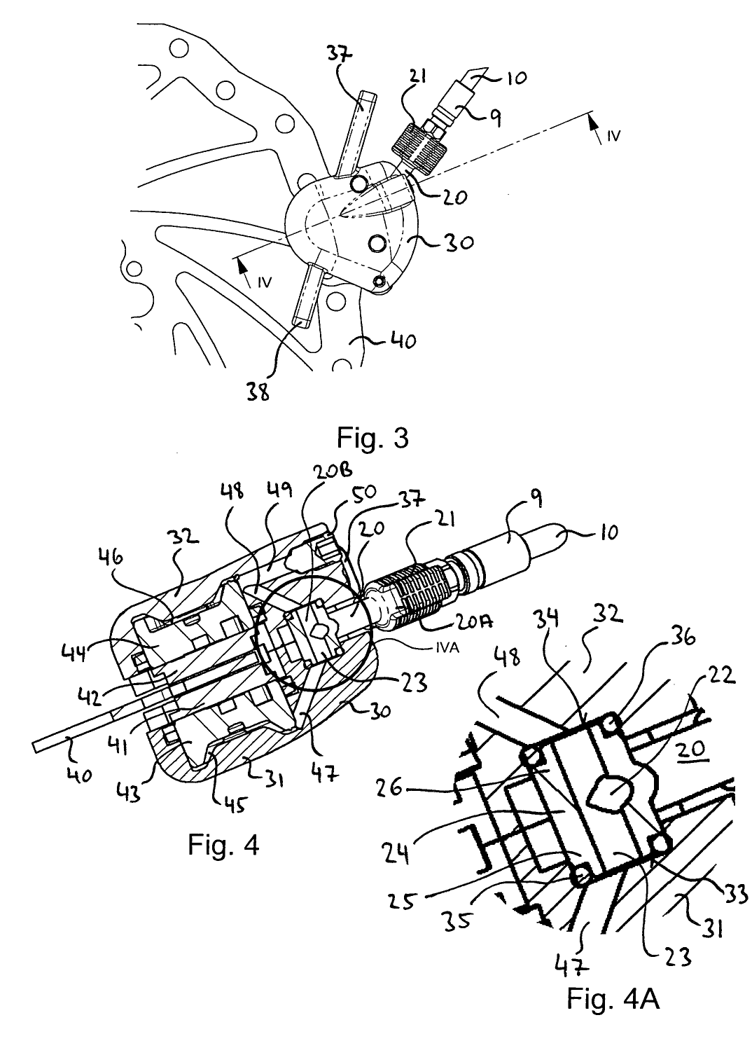

FIG. 3 shows a side view of a brake calliper according to an embodiment of the invention, having a connection piece according to an embodiment of the invention.

FIG. 4 shows a side view of the brake calliper and of the connection piece of FIG. 3 along the line IV-IV of FIG. 3.

FIG. 4A shows a greatly enlarged section of FIG. 4 of the region characterized in FIG. 4 by the circle IVA.

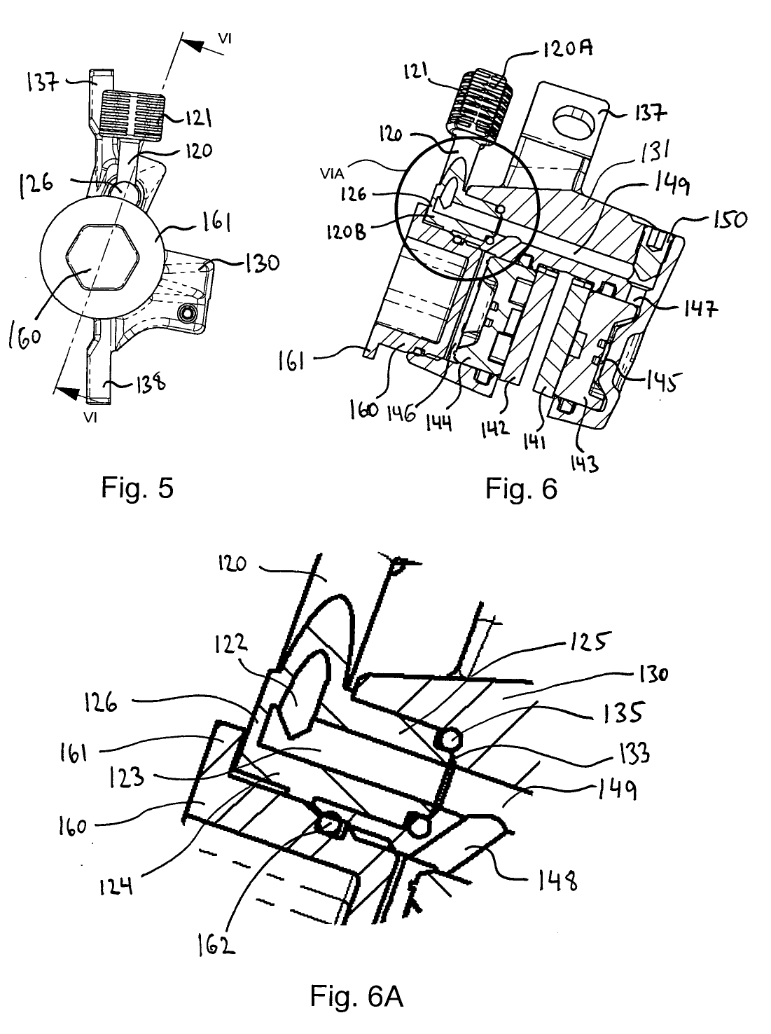

FIG. 5 shows a side view of a brake calliper according to a further embodiment of the invention, having a connection piece according to a further embodiment of the invention.

FIG. 6 shows a sectional view of the brake calliper and of the connection piece of FIG. 5 along the line VI-VI of FIG. 5.

FIG. 6A shows a greatly enlarged section of FIG. 6 of the region characterized in FIG. 6 by the circle VIA.

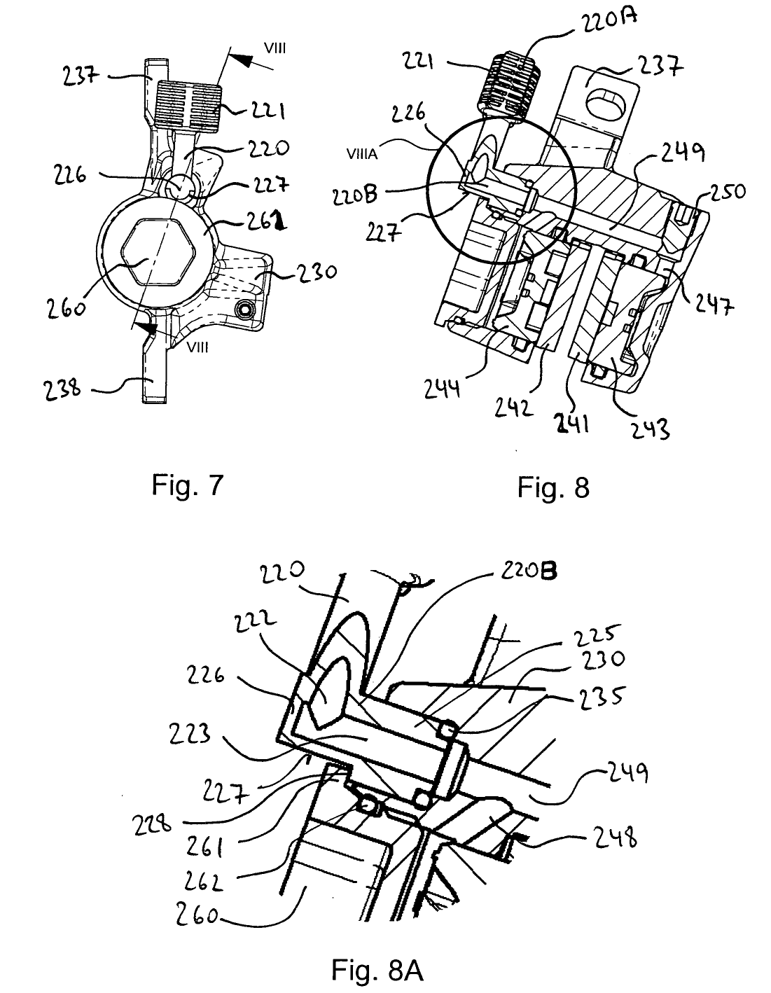

FIG. 7 shows a side view of a brake calliper according to a further embodiment of the invention, having a connection piece according to a further embodiment of the invention.

FIG. 8 shows a sectional view of the brake calliper and of the connection piece of FIG. 7 along the line VIII-VIII of FIG. 7.

FIG. 8A shows a greatly enlarged section of FIG. 8 of the region characterized in FIG. 8 by the circle VIIIA.

FIGS. 3, 4 and 4A show a brake calliper 30 and a connection piece 20 according to an embodiment of the invention. The brake calliper has a two-part housing comprising a first housing part 31 and a second housing part 32. Formed in each housing part is a brake cylinder in which a brake piston 43, 44 carrying a brake lining 41, 42 is arranged in a manner known to the person skilled in the art. A brake disc 40 shown only in part is arranged between the brake linings 41, 42. The housing part 32 has fastening sections 37, 38 by means of which the brake calliper 30 can be mounted in a known manner on a frame part of a bicycle, which frame part is not shown.

A hydraulic pipe 10 is fastened to a connection piece 20 by means of a clamping piece 9.

The connection piece 20 has a fastening section 20A for fastening the hydraulic pipe 10 to the connection piece 20 and a connection section 20B for connecting the connection piece 20 to the brake calliper 30.

A cooling element 21 is provided on the connection piece 20, in the region of the fastening section 20A, for removing heat transmitted from the brake calliper to the connection piece 20, so that less heat is transmitted to the hydraulic pipe 10 and the clamping piece 9.

The connection section 20B of the connection piece 20 comprises an annular region 24 from which in each case an extension 25, 26 extends laterally. A step for holding a gasket 35, 36 is provided in each case at the end on the outer surface of the extensions 25, 26. Alternatively, it is also possible to provide, for sealing, an all-round groove which is formed in the extension or the corresponding housing part and in which a sealing element is arranged.

A pipe 22 which merges with a pipe 23 running in the annular region 24 and the extensions 25, 26 is provided in the connection piece 20.

The connection piece 20 is arranged with the two extensions 25, 26 in corresponding connection openings 33, 34 which in each case are formed in one of the housing parts 31, 32. The extensions 25, 26 have a circular cross-section which substantially corresponds to the circular cross-section of the connection openings 33, 34. As a result of this, the connection piece 20 can be mounted at a desired angle relative to the brake calliper in order to adapt the path or exit of the hydraulic pipe optimally to the conditions of the bicycle or of the frame part to which the brake calliper is fastened. The seal with the gaskets 35, 36 is preferably a radial seal. This has the advantage that only the tolerances between the radius of the step of the extensions and the radius of the connection opening 32, 34 may be taken into account, and the housing parts 31, 32 can be arranged firmly against one another.

The pipe 23 has in each case a fluid connection to a pipe 47, 48, which in turn has a fluid connection to the corresponding pressure space 45, 46. The housing part 32 furthermore has a vent pipe 49 which is closed by a screw 50. The filling and the operation of such a brake system is known to the person skilled in the art, so that reference is made to the prior art.

FIGS. 5, 6 and 6A show a brake calliper 130 and a connection piece 120 according to a further embodiment of the invention, the brake disc, the clamping piece and the hydraulic pipe not being shown for the sake of clarity. Since many parts and features correspond to the parts and features of the working example described with reference to FIGS. 3, 4 and 4A or are similar thereto, reference is made to the description of this working example, and only the differences are explained below. It should be noted that corresponding parts or similar parts have reference numerals incremented by the value 100, i.e. here, for example, reference is made to the connection piece (20 above) with the reference numeral 120. The clamping piece 9 and hydraulic pipe 10 are mounted on the fastening section 120, corresponding to FIGS. 3 and 4, in order to connect the brake calliper to the hydraulic system. In the figures, these components are not shown.

The brake calliper 130 has a one-part housing 131. A mounting opening through which at least one of the brake pistons 144 can be inserted into the brake cylinder is provided on one of its sides. The mounting opening is closed by a closure element 160, which after insertion of the brake piston 144 (and possibly of the brake piston 143 beforehand), is screwed into the mounting opening and seals the brake cylinder to the outside by means of the seal 162.

The closure element 160 has an all-round flange 161 which, as can best be seen in FIG. 6A, secures the connection piece 120 in the connection opening 133 by an interlocking connection.

The connection piece 120 has, as above, a fastening section 120A on which a cooling element 121 is mounted. The connection piece 120 is substantially L-shaped. In the connection section 120B, the connection piece 120 has an annular region 124 which is closed by a wall 126 on the side facing the flange 161 of the closure element 160. On the other side facing away from the brake calliper, the connection section 120B has an extension 125. The extension 125 has substantially the same cross-section as the annular region 124 or the wall 126. A pipe 122 which merges with a pipe 123 in the annular region and the extension is provided in the fastening section.

When the connection piece 120 is mounted, the pipe 123 has a fluid connection to the pipe 149 which distributes the fluid via the pipes 147, 148 over the pressure spaces 145, 146.

FIGS. 7, 8 and 8A show a brake calliper 230 and a connection piece 220 according to a further embodiment of the invention, the brake disc, the clamping piece and the hydraulic pipe not being shown for the sake of clarity. Since, as in the last working example, many parts and features correspond to the parts and features of the working example described with reference to FIGS. 3, 4 and 4A or are similar thereto, reference is made to the description of this working example, and only the differences are explained below. It should be noted that corresponding parts or similar parts have reference numerals incremented by the value 200, i.e. here, for example, reference is made to the connection piece (20 or 120 above) with the reference numeral 220. The clamping piece 9 and the hydraulic pipe 10 are mounted, corresponding to FIGS. 3 and 4, on the fastening section 120 in order to connect the brake calliper to the hydraulic system. In the figures, these components are not shown.

This embodiment substantially corresponds to the embodiment of FIGS. 5, 6 and 6A, so that reference is made to the description thereof for the same features. The difference is substantially in the formation of the connection region 120B of the connection piece 120 and the closure element 160.

The connection region 120B has a segment-like recess 227 which extends over the wall 226, the annular region and into the extension 225. It can also be said that an intermediate section or transition region which has a smaller cross-section than the extension is present between the annular region and the extension. In any case, a step 228 which the flange 261 of the closure element 260 engages in order to secure the mounted connection piece 220 in the brake calliper 230 with an interlocking connection is provided in the connection region 220B.

Since the flange 162 engages the connection piece further inside relative to the previous working example, the closure element 260 is shorter than the corresponding closure element 160.

In the case of the working examples shown, the connection piece 20, 120, 220 may be formed from a material having good thermal conductivity or normal conductivity. In the case of the working examples shown, the connection piece 20, 120, 220 can, however, also be formed at least partly or completely from a poorly heat-conducting material, such as, for example, stainless steel. It is preferable if it is formed partly or completely from a poorly heat-conducting material and the cooling element 21, 121, 221 is omitted or is formed from a material having good thermal conductivity. Alternatively or additionally, the clamping piece 9 (shown only in FIGS. 3 and 4) can be formed from a poorly heat-conducting material, such as, for example, stainless steel.

1. Connection piece for connecting a hydraulic pipe to a brake calliper, a brake cylinder, a slave cylinder and/or a master cylinder for a hydraulic brake and/or hydraulic clutch, comprising
a fastening section for fastening the hydraulic pipe to the connection piece and a connection section for connecting the connection piece to the hydraulic system,
the connection section having an annular region,
wherein the connection section has at least one extension which extends from the annular region substantially laterally to a plane of the annular region.

2. Connection piece according to claim 1, wherein the at least one extension is a lateral extension of the annular region.

3. Connection piece according to claim 1, wherein the at least one extension has an annular surface.

4 Connection piece according to claim 1, wherein one of the annular region, the at least one extension and a transition region between the annular region and extension has a segment-like recess.

5. Connection piece according to claim 1, wherein the at least one extension has a section having a cross-section greater than a cross-section of the annular region.

6. Connection piece according to claim 5, wherein the section of greater cross-section of the at least one extension forms a flange fastening the connection piece to the brake calliper.

7. Connection piece according to claim 5, characterized wherein the at least one extension has, between the annular region and the section of greater cross-section, an intermediate section having a cross-section corresponding substantially to the cross-section of the annular region.

8. Connection piece according to claim 1, wherein a cross-section of the at least one extension corresponds to a cross-section of the annular region.

9. Connection piece according to claim 1, wherein the at least one extension has an all-round groove for receiving a gasket.

10. Connection piece according to claim 1, wherein the at least one extension has an all-round step for receiving a gasket.

11. Connection piece according to claim 1, wherein the at least one extension has an all-round sealing surface arranged at an end of the at least one extension remote from the annular region.

12. Connection piece according to claim 1, wherein a pipe is formed in the at least one extension.

13. Connection piece according to claim 1, wherein the connection piece is substantially L-shaped, the fastening section substantially forms a leg of the substantially L-shaped connection piece, the extension forms another leg of the substantially L-shaped connection piece, and the annular region forms a connection region of the two legs of the substantially L-shaped connection piece.

14. Connection piece according to claim 1, wherein the at least one extension is formed on one side of the annular region.

15. Connection piece according to claim 1, wherein the annular region has, on a side opposite the at least one extension, a wall which laterally seals the annular region.

16. Connection piece according to claim 1, wherein the connection piece has an extension on each of two sides of the annular region.

17. Connection piece according to claim 16, wherein the two extensions are formed symmetrically and identically.

18. Connection piece according to claim 16, wherein the two extensions are of different lengths.

19. Connection piece according to claim 1, wherein the connection piece is formed at least partly in the fastening section and completely of a poorly heat-conducting material.

20. Connection piece for connecting a hydraulic pipe to a brake calliper for a hydraulic brake, comprising a cooling element in the connection piece and for removing heat picked up by the brake calliper during the braking process and transmitted to the connection piece.

21. Connection piece according to claim 20, wherein the connection piece has a fastening section for fastening the hydraulic pipe to the connection piece and a connection section for connecting the connection piece to the brake calliper of the hydraulic system, the cooling element being arranged on the fastening section.

22. Connection piece according to claim 20, wherein the cooling element has cooling ribs arranged substantially in a cuboid manner, the cooling element being formed from a material having good thermal conductivity.

23. Connection piece according to claim 20, wherein the or a further cooling element is arranged on the fastening section of the hydraulic pipe.

24. (canceled)

25. Brake calliper for a hydraulic brake, comprising a housing in which a disc space for receiving a brake disc and at least one brake cylinder for receiving a brake piston is formed, a connection opening for receiving a connection piece for connecting a hydraulic pipe to the brake calliper provided in the housing,
wherein the connection piece is inserted into the connection opening, and wherein the brake calliper has securing means for securing the connection piece in the connection opening in an interlocking manner.

26. Brake calliper according to claim 25 wherein the at least one brake cylinder is connected to the disc space and has, on a side opposite the disc space, a mounting opening through which the brake piston is inserted into the brake cylinder.

27. Brake calliper according to claim 26 wherein the brake calliper has a closure element for closing the mounting opening, and the securing means comprise the closure element.

28. Brake calliper according to claim 25, wherein the closure element is screwed into the mounting opening and has a flange for securing a connection piece arranged in the connection opening.

29. Brake calliper according to claim 25, wherein the connection opening has a groove for receiving a sealing element for sealing the connection piece arranged in the connection opening.

30. Brake calliper according to claim 25, wherein the brake calliper has a one-part housing, and wherein the connection opening is arranged next to a mounting opening for the brake piston.

31. Brake calliper according to claim 25, wherein the brake calliper has a two-part housing, the connection opening being arranged in at least one of the housing parts of the brake calliper, on a side opposite the other housing part.

32. Brake calliper according to claim 31 wherein the securing means comprise that housing part of the brake calliper which is opposite the connection opening.

33. Brake calliper according to claim 31, wherein the connection opening is provided in each of the two housing parts.

34. Brake calliper according to claim 33, wherein the two connection openings are formed opposite one another and symmetrically relative to one another.

35. Brake calliper for a hydraulic brake, comprising a housing in which is formed a disc space for receiving a brake disc and at least one brake cylinder for receiving a brake piston, wherein the housing is connected to the disc space and has, on a side opposite the disc space, a mounting opening through which the brake piston is inserted into the brake cylinder,
a closure element for closing the mounting opening, and
a connection piece for connecting a hydraulic pipe to the brake calliper, wherein
the closure element, when in a position closing the mounting opening, secures the connection piece on the housing.

36-37. (canceled)
